(19) United States
(12) Patent Application Publication
(10) Pub. No.: US 2025/0166935 A1
(43) Pub. Date: May 22, 2025

(54) CONTACT FOR HIGH AMPERAGE SWITCH AND TEST METHOD FOR IDENTIFICATION OF CAUSES OF CONTACT FAILURE

(71) Applicant: Royal Switchgear Manufacturing Company, LLC, Bessemer, AL (US)

(72) Inventors: Thomas Lee Moland, Helena, AL (US); Steven Patrick Donahue, Birmingham, AL (US); Roland Sion Timsit, Toronto (CA)

(21) Appl. No.: 18/952,716

(22) Filed: Nov. 19, 2024

Related U.S. Application Data
(60) Provisional application No. 63/600,985, filed on Nov. 20, 2023.

(51) Int. Cl. H01H 1/00; G01N 17/00; H01H 1/025; H01H 1/50; H01H 1/62

(52) U.S. Cl. CPC H01H 1/0015; G01N 17/006; H01H 1/025; H01H 1/50; H01H 1/62

(57) ABSTRACT

A method of testing contacts of a high voltage switch to replicate corrosion fretting exhibited by switches used with renewable energy generators. The method comprises a test assembly being constructed which comprises a vertical break switch having a plurality of contacts. The switch is connected to a high current, low voltage continuous current test loop. A plurality of thermocouples is attached along multiple locations on the switch, the contacts and the test assembly. A vibratory motor is mounted to the test assembly and the plurality of contacts are overloaded by applying current to the test assembly in an amount more than two times a designated current density for the contacts. The contacts being allowed to reach a thermal equilibrium and activating the vibratory motor.

### CROSS-REFERENCE TO RELATED APPLICATION

The present application claims priority to and the benefit of the filing date of U.S. Provisional Patent Application No. 63/600,985 filed Nov. 20, 2023 which is hereby expressly incorporated by reference in its entirety as if set forth fully herein.

### FIELD

Embodiments presented herein relate generally to a contact for a high amperage switch and a test method of identifying the causes of contact failure and for developing an improved contact design. More particularly, embodiments presented herein are directed to a contact having improved plating characteristics and increased contact pressure and a test method for simulating corrosion fretting.

### BACKGROUND

High amperage disconnect switches on the order of 4000 A to 5000 A are generally known in the art and many of their components have been field-proven for traditional electric high-voltage firm power systems. Prior to releasing such switches, switch designers and manufacturers can perform a number of different design tests on a new switch design to confirm the design's operability, level of performance. limitations and longevity and to identify and correct possible failures. Such design tests can include:
Continuous Current—the continuous current test, also known as a temperature-rise test, is a procedure where nameplate-rated continuous current is passed through the air break switch until the switch reaches thermal stability. The switch is permitted a maximum rise of 53° C. above the ambient temperature and to pass the test must not rise more than 1° C. over three (3) consecutive measurements that are thirty (30) minutes apart.
Switch Performance—the switch performance test is a procedure where 180% of nameplate-rated current is passed though the circuit breaker until the switch reaches thermal equilibrium. Although the temperature rise can be recorded, the main purpose of the test is to verify there is no thermal run away of the components (i.e. no more than 3% temperature increase over four (4) hours). Typically, this test can take over eight (8) hours to complete.
Mechanical Operations—the mechanical operations test can be a key reliability and performance evaluation procedure. This test assesses the switch's mechanical functionality without applying electrical current. Some of the primary objectives of such test can be to verify operational smoothness, identify mechanical wear, confirm proper actuation, accessing timing accuracy and check auxiliary contacts. The test can involve a operating the switch between the open and closed condition a specified number of times (e.g. 1000). Frequently, a portion of the operations (e.g. 100) can utilize a terminal pad loading of a direction and magnitude that is specified in the applicable standard.

These design tests have been developed over decades of practical experience and are meant to simulate the most severe service conditions the switch might be exposed to. In principle, if a disconnect switch passes the design tests, it is expected that it is fit for purpose to provide decades of reliable service.

In more recent years, high amperage switches have been put into use in connection with renewable energy systems including for example solar photovoltaics and wind. Following such implementation, it has been observed that certain high amperage switches have experienced field failures when deployed in renewable energy systems that are not attributed to typical failure modes for air break disconnect switches. Typical disconnect failures can result because the switch is not fully closed, whereas the observed high amperage switch failures were thought to originate at one or more switch contacts on account of the switches having been properly adjusted and the disconnect exhibiting signs of excessive heating and varying degrees of heat damage. Notably, these failures have been observed at renewable sites—wind, solar, battery—and all have been at 34.5 kV voltage and a current of 3000 A or greater. The reported failure rate had been up to 8% for the class of switch used in these applications, whereas such high amperage switches have not experienced failure outside of renewable energy sites. Such failures indicate that there is some factor present at renewable sites unanticipated by the standard testing.

In carrying out evaluations during the development of embodiments presented herein, switches exhibiting the aforementioned failures were thoroughly retested and evaluated in accordance with the IEEE C37.30.1-2011. The switches exceeded the requirements set forth by the standard. Due to the rate of failure experienced at these sites, a need has arisen for a test method to identify the root cause of such failure and to develop a custom testing plan to validate improved field performance. After identifying the root cause of failures and developing a test to simulate premature failures, specific design changes were required to prevent this previously unknown failure mode.

### SUMMARY OF THE INVENTION

A method testing contacts of a high voltage switch to replicate corrosion fretting exhibited by switches used with renewable energy generators is provided herein. According to embodiments presented herein, the method can comprise the construction of a test assembly comprising a vertical break test switch having a plurality of contacts. The test switch can be connected to a high current, low voltage continuous current test loop. The method can further comprise a plurality of thermocouples being attached along multiple locations on the test switch, the plurality of contacts and the test assembly. A vibratory motor can be mounted to the test assembly and the plurality of contacts can be overloaded by applying current to the test assembly in an amount more than two times a designated current density for said plurality of contacts. The plurality of contacts can be allowed to reach a thermal equilibrium and the vibratory motor can be activated. The switch can be operated until the plurality of contacts achieve a temperature increase over an ambient temperature for the plurality of contacts.

According to embodiments presented herein, the plurality of contacts for the method of testing contacts of a high voltage switch can comprise two contacts, where each of the two contacts can have an outer surface engaged against an outer edge of a contact plug. Further, the corrosion fretting can be exhibited along the outside surface of the contacts and be presented as a linear path of wear extending horizontally across the outside surface of the contacts. The vertical break test switch can be a 34 kV, 4000 A switch, and the current applied to the test assembly to overload the plurality of contracts can be on the order of 2000 amps.

According to disclosed embodiments, the plurality of contacts for the method of testing can be overloaded by the application of current in an amount of at least two and a half times the designated current density for said plurality of contacts. The plurality of contacts used for the test can be unlubricated and the testing can comprise operating the vibratory motor at 2400 revolutions per minute and producing a movement amplitude on an order of 0.0005 inches. Further, the switch can be operated until the plurality of contacts achieve a temperature increase of at least ten percent higher than the ambient temperature for the plurality of contacts.

Embodiments presented herein can further comprise a contact for a high voltage switch. The contact can comprise a copper body comprising a U-shaped band that can have first and second segments having first terminal ends and opposing ends joined together by a curved segment. The first segment can be substantially straight along its length, the second segment can have a bend along its length between a first portion and a second portion, the first portion of the second member can be substantially parallel to first member and the second portion of the second member can angle toward the first member as it extends from the first segment to the curved segment. The first portion of the second segment of copper body can further be covered by a silver plating along at least a portion thereof, and the first segment of copper body can be covered by a plating of tin along at least a portion thereof.

According to exemplary embodiments, the silver plating of the contact can cover a contact surface for engaging against a side of a contact plug. The silver plating can have a semi-bright finish and a thickness on the order of between 0.0005 and 0.0012 inches. The first segment of the contact can have at least one opening therethrough for fixedly securing the contact to a contact assembly. The silver plating can have a thickness on the order of 0.0008 inches. The plating of tin can be provided in a location of the at least one opening.

Embodiments presented herein are further directed to a contact assembly for a high voltage switch. According to such embodiments, the contact assembly can comprise a contact body exhibiting a c-shaped member having a central channel between opposing parallel first and second flanges that can extend from opposing sides of the channel. The assembly can further comprise a plurality of contacts. Each contact can comprise U-shaped copper band having a first and second segments with first terminal ends and opposing ends joined together by a curved segment. The first segment of the contact can be substantially straight along its length and the second segment can have a bend along its length between a first portion and a second portion. The first portion of the second member can be substantially parallel to first member and the second portion of the second member can angle toward the first member as it extends from the first segment to the curved segment. The first portion of the second segment of the copper body can be covered by a silver plating along at least a portion thereof, and the first segment of copper body can be covered by a plating of tin along at least a portion thereof.

The plurality of contacts of the contact assembly can further comprise a first contact secured to the first flange of the contact body and a second contact fixedly secured to the second flange of the contact body. The first contact can be secured such that at least a portion of the second segment of the first contact extends into the channel of the contact body and can be adjacent to an interior surface of the first flange with a space therebetween. The second contact can be secured such that at least a portion of the second segment of the second contact extends into the channel of the contact body and can be adjacent to an interior surface of the second flange with a space therebetween.

According to exemplary embodiments, the contact assembly can further comprise a contact plug within the channel of the contact body. The contact plug can have first and second outer edges. A plurality of biasing members can further be provided which comprise a first biasing member secured to the first flange of the contact body and a second biasing member secured to the second flange of the biasing member. The first biasing member can extend between the inside surface of the first flange and the inside surface of the first contact in the space therebetween. The first biasing member can provide a force to influence the second segment of the first contact toward the first outer edge of the contact plug such that the outer surface of the second segment of the first contact can be engaged against the first outer surface of the contact plug. The second biasing member can extend between the inside surface of the second flange and the inside surface of the second contact in the space therebetween. The second biasing member can provide a force to influence the second segment of the second contact toward the second outer edge of the contact plug such that the outer surface of the second segment of the second contact can be engaged against the second outer surface of the contact plug.

According to embodiments presented herein, the plurality of biasing members of the contact assembly can be springs that can be compressed in a respective space between one of the first and second flanges of the contact body and the inside surface of the second segment of a respective one of the first and second contacts. The springs can have an equilibrium position that forces the springs inward toward a respective one of the first and second outer edge of the contact plug. The springs can be an A-23362-type spring having a spring rate on the order of 721 #/in.

Embodiments presented herein can further provide for a contact assembly where the silver plating along the copper body of the plurality of contacts can cover a contact surface between a respective one of the plurality of contacts and a respective one of the first and second outer edge of the contact plug. The silver plating can have a semi-bright finish and a thickness on the order of between 0.0005 and 0.0012 inches. The first segment of each of the plurality of contacts can have at least one opening therethrough for fixedly securing the contact to the contact body. The silver plating can further have a thickness on the order of 0.0008 inches. The plating of tin is provided in a location of the at least one opening.

### BRIEF DESCRIPTION OF THE DRAWINGS

FIG. 1 is a schematic view of a progression of oxide buildup that can occur during corrosion fretting.

FIG. 2 is a perspective view of a representative contact for a high amperage switch and movement between the contact surfaces.

FIG. 3 is a perspective view of a test assembly according to embodiments presented herein.

FIG. 4 is a front detailed view of a portion of a contact finger exhibiting corrosion fretting from use in the field in connection with a renewable energy system.

FIG. 5 is a front detail view of a portion of a contact finger exhibiting corrosion fretting following testing according to embodiments presented herein.

FIG. 6 is a side elevation view and detail views of a contact finger according to embodiments presented herein.

FIG. 7 is a cross-section view of a contact according to embodiments presented herein.

### DETAILED DESCRIPTION

While the subject invention is susceptible of embodiment in many different forms, there will be described herein in specific detail, embodiments thereof with the understanding that the present disclosure is to be considered as an exemplification of the principles of the invention and is not intended to limit the invention to the specific embodiments illustrated.

Embodiments presented herein are directed to a method to test high amperage switches to identify failures exhibited in renewable energy systems. Embodiments of the subject disclosure are further directed to the design and construction of a switch contact having better performance for renewable energy applications so as to overcome the commonly observed failures or at least reduce frequency of such failures. In carrying out such evaluation, the following areas were thoroughly investigated and/or tested by high voltage equipment design consultants that possess the requisite level of knowledge, skill and experience to be regarded as persons of ordinary skill in the art of high amperage switches:
Environmental testing was performed in the form of salt fog aging. The intent of such testing was mainly to simulate a level of corrosion that is representative of at least a year in service and perform continuous current testing.
Harmonics produced by the renewable energy non-linear generation sources. Many users of such high amperage switches did not have harmonic filters installed in their systems, so an analysis was performed to determine the 60 Hz equivalent heating of the higher order harmonics.
Electric and magnetic fields analysis of the switch contacts and adjacent phases. This study was intended to identify any inherent design flaws that are internal to the switch contact design or in the application at 34.5 kV.
Contact design review of the plating methods, contact forces, part geometries and potential vulnerabilities concerning switch contact failure modes.

Investigation and subsequent testing revealed corrosion fretting to be to be the root cause of the failures. More specifically, it was determined that micromovements or vibrations between the contact surfaces can accelerate the formation of non-conductive oxides at the moving contacts of the switch. It was determined that these non-conductive oxides can cumulatively build over time and cause overheating of the contacts and eventual failure. The harmonics and EMF forces present in renewable sites can amplify the conditions that cause this phenomenon. Such testing and evaluation has resulted in the development of an optimized contact design that mitigates the impacts of corrosion fretting and has demonstrated a 3,300% improvement over the current design in laboratory testing.

The initial focus of the investigation described herein focused on environmental causes of switch failures, and more particularly whether field conditions were causing the switch contacts to overheat and eventually fail. In accordance therewith, a test plan was developed to artificially age the switch contact assembly with a variety of contact platings and oxide inhibitors. A heat rise test was performed on each of the assemblies both before and after 192-hour salt fog tests. Although such tests did not recreate the field failures in full as there was only a 9% increase in temperature rise after salt fog, the results demonstrated that the use of an oxide inhibitor such as Penetrox A could improve the performance of the switch and avoid oxidation in response to adverse environmental conditions.

Harmonics testing was carried out based on the recognition that a significant amount of current harmonics can be produced by wind turbines and other non-linear generation sources. IEEE 519 is the standard that defines acceptable limits of harmonics at the point of common coupling (PCC) which is usually on the high voltage side of the transformer. In researching the state of harmonics studies, it was determined that most, if not all, evaluations are at the PCC and do not concern the 34.5 kV collector bus equipment.

One issue with high frequency harmonics can be that losses in the form of heat do not register on conventional current transformers. To fully understand this impact to switch performance, an analysis of current harmonics was undertaken on the 34.5 kV collector bus at a typical station with no harmonic filtering equipment. Below is a table of results showing the typical 60 Hz RMS equivalent amps that would be present.

TABLE 1
Calculated equivalent 60 Hz RMS current of a typical windfarm

| Harmonic order | Frequency (Hz) | Magnitude RMS amps |
|---|---|---|
| 11 | 660 | 175 |
| 13 | 780 | 120 |
| 41 | 2460 | 105 |
| 67 | 4020 | 40 |
| 1 | 60 | 3500 |

In the example above, the switch was shown to register operating at 3,500 A but, is exposed to an additional 440 A of higher frequency current that is not recorded by the station current transformers (CTs). This excess current, and subsequent heating, was well within the design margins of the disconnect switch.

Electric and Magnetic Field Analysis was undertaken based on the recognition that as current increases, the electromotive force (EMF) can induce unwanted currents that can reduce switch performance. Testing carried out pursuant to the standards of the Institute of Electrical and Electronics Engineers (“IEEE”) is usually sufficient to predict satisfactory performance. However, IEEE testing permits single phase testing which can lead to compound failures. More particularly, once one of the contact fingers fails, the other fingers are overloaded causing complete failure of the contacts. As such, a different process was followed with the aim of eliminating the possibility of adjacent phases causing induced currents and potentially overloading one of the contact fingers.

According to embodiments practiced herein, the contact assembly was modeled using QuickField™ software and the currents generated by the harmonics analysis were used in the model. Adjacent phases at minimum phase spacing were also included in the analysis. The modeling showed that the outer contact fingers would be exposed to 17% more current than the inner fingers. In the worst case, the outermost finger would be exposed to 466 A (10 fingers per phase) instead of the normal 400 A.

Such observations lead to the performance of significant overload testing on the contact fingers at a current density of 1,000 A per contact finger, 2.5 times the design current. Such testing however did not replicate the contact marking or damage that is commonly exhibited with degraded contacts.

Corrosion fretting is a well-known and common mode of failure in low voltage connectors such as automotive connectors but is a previously unknown phenomenon with respect to high voltage switches. Corrosion fretting is caused by the micromovements between make-break contacts of the switch. These small movements accelerate the oxidation of some plating metals that are used in high voltage switch contacts. At ambient temperatures, these movements induce only mechanical wear, but when exposed to the elevated operating temperatures that are typical on high voltage switches, a chemical reaction occurs that accelerates the corrosion and causes the formation of non-conductive oxides. Over time, these non-conductive oxides can build, cause excess heating, and eventual arcing and failure of the contacts.

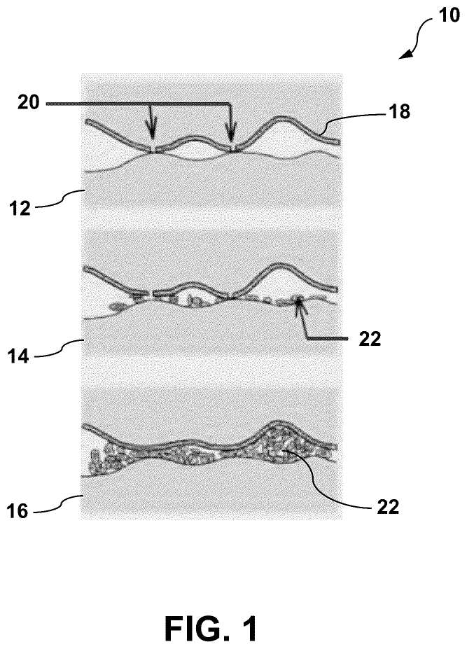

FIG. 1 is a schematic view illustrating a progression 10 of oxide buildup that can occur on switch contact surfaces during corrosion fretting. As shown schematically in FIG. 1, oxide buildup is shown as a progression from a first condition 12, a second condition 14 and a third condition 16 as oscillatory displacement occurs over time from oscillatory movement between the respective contact surfaces. More particularly, as is commonly known oxide film 18 in the nature of a thin layer of oxide components can form on the metal surface of a switch contact from extended exposure to oxygen.

As shown in FIG. 1, the oxide film 18 can exhibit cracks 20 at or around the contact points between the contacts. Such cracks can be caused by the oscillatory movement of the surfaces relative one another and the friction generated therebetween. Continued friction caused by the periodic oscillatory movement between the contact surfaces can cause the oxide film 18 to break apart in and around the cracks 20 which can cause the buildup of oxidized debris 22 in the nature of small particles of oxidized components. As shown schematically in FIG. 1, over time and with periodic oscillatory movement/displacement, the oxidized debris 22 can build in the micro spaces between the contact surfaces. As specified above, the buildup of the oxidized debris 22 can lead to failure of the contacts from excessive heating and arching.

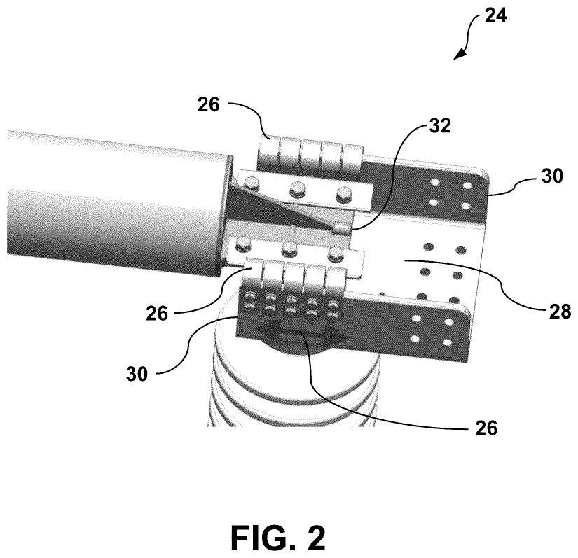

FIG. 2 is a schematic view of a representative high-voltage switch 24 of 40000 A vertical breaker and illustrates the direction of oscillatory motion 26 that can lead to corrosion fretting. As shown schematically in FIG. 2, as is known in the art, switch 24 can comprise a plurality of contact fingers 26 fixedly secured to a contact assembly 28 which may be of an aluminum construction, and more particularly to the outside flanges 30 thereof. According to representative embodiments, the switch 24 can comprise a contact plug 32 that can interface with contact assembly 28. More particularly, contact plug 32 can have a segment that can at least in part be aligned and seated within a central channel of contact assembly 28 between the opposing flanges 30. The outside edges of at least a portion of contact plug 28 can be flush against an outside edge of the contact fingers 26

As shown schematically in FIG. 2, contact plug 32 can be subject to oscillatory movement 26 relative the contact assembly 28 and contact fingers 26. The direction of movement 26 can be such that contact plug 28 and contact assembly 28 are subject to periodic or reciprocating back-and-forth lateral motion relative one another along a substantially straight line whereby contact plug 28 can slide along the length of the interior channel of contact assembly 28 laterally across the outer face or surface of contact fingers 26. As described previously, such movement can lead to corrosion fretting of the type described and shown in FIG. 1.

Typical laboratory tests for corrosion fretting target a known frequency and amplitude of vibration but may not replicate conditions of the field. Accordingly, one objective of testing was to recreate the field conditions of contact failure and test an improved designs under the same conditions. Such testing can be conducted as an alternative to having to expend the time and expense to acquire field data of the vibration frequency or amplitude of vibration.

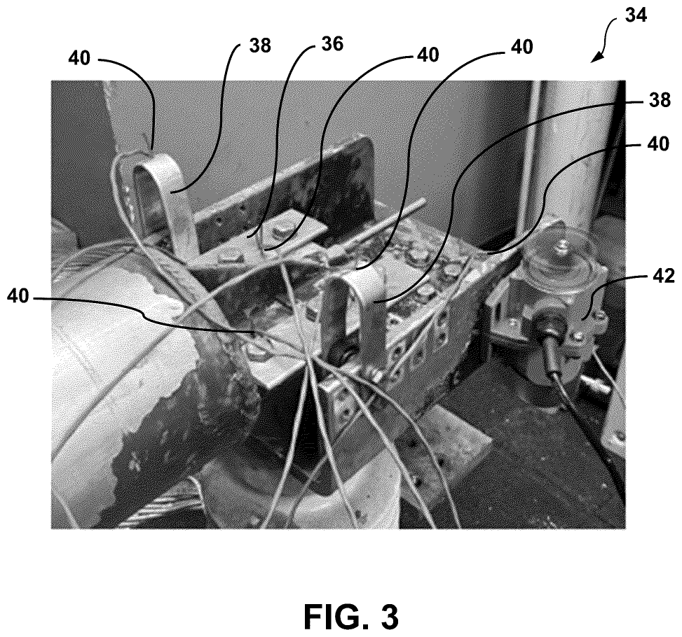

FIG. 3 illustrates a representative test assembly 34 according to exemplary embodiments presented herein. The test assembly 34 can be constructed to replicate the construction of a 4000 A vertical break switch. As shown in FIG. 3 the test assembly 34 can use a 34 kV, 4000 A vertical break test switch 36 connected to a high current, low voltage continuous current test loop. According to embodiments presented herein, tests can be performed with 2000 A of current and two (2) contact fingers 38 as an alternative to the usual ten (10) contacts. Persons of ordinary skill in the art however will understand that the test according to embodiments presented herein can utilize any number of contact fingers without departing from the scope of the subject invention. In carrying out the test according to embodiments presented herein, the switch contacts 38 can be overloaded by at least two and a half (2.5) times the normal designed current density. Although some commercially available contacts can have a lubrication such as grease applied at their respective location of manufacture as a means to resist the effects of corrosion fretting, the reapplication of such lubrication is not a customary practice in the industry. Accordingly, the test method according to embodiments presented herein can be performed on “dry” contacts without lubrication to better simulate field conditions of the switch contact.

As shown in FIG. 3, thermocouples 40 can be attached to multiple locations on the switch 36 and contacts 38 and a vibratory motor 42 can be mounted to the contact assembly 34, and more particularly motor 42 can be secured to the outer surface of a flange of assembly 34. Once the contact fingers 38 reach a thermal equilibrium, the vibratory motor 42 mounted to the contact assembly can be turned on and operated at 2400 RPMs with a movement amplitude of approximately 0.0005″. The switch 36 can then be operated until there is a thirty percent (30%) increase in the temperature rise of the contacts and at that point the test can be concluded. It will be readily understood by persons of ordinary skill in the art that the vibratory motor 42 can be turned on at any point during the tests and that the motor power and movement amplitude can fluctuate, including being higher or lower, without departing from the inventive scope of embodiments presented herein. It will be further understood that the switch 36 can be operated, and the test continued, after the contacts 38 exhibit a temperature rise of thirty percent (30%). The testing according to the method described herein can successfully replicate corrosion fretting as exhibited by field-deployed switch contacts and be relied upon to evaluate modifications to contact design for improved performance and resistance to corrosion fretting.

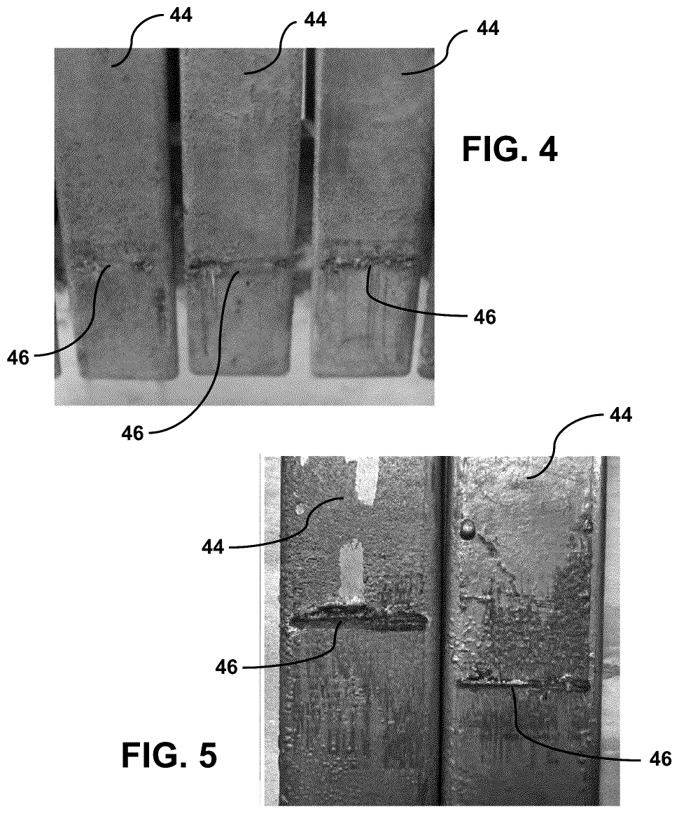

FIGS. 4 and 5 are detail views of a contact finger 44 exhibiting corrosion fretting across the outer contact surface that would engage the outer surface of a contact plug. More particularly, FIG. 4 illustrates identifiable characteristics of corrosion fretting 46 along a contact finger 44 from use in the field with a switch for a renewable energy generator, whereas FIG. 5 illustrates identifiable characteristics of corrosion fretting 46 along a contact finger 44 following testing of according to embodiments presented herein. As shown in FIGS. 4 and 5, corrosion fretting 46 can be recognized and observed by the formation of a narrow band or groove resembling a scratch or laceration along the surface of the contact finger 44. As described above, persons of ordinary skill in the art will recognize that such scratch is caused by the contact finger 46 scraping the adjacent outer edge of the contact plug from oscillatory movement between such members whereby such movement causes the location of contact along the contact finger 44 to be worn away or cracked to form to exhibit corrosion in the nature of an oxide film and/or oxidized debris. Notably, the narrow band of corrosion fretting 46 exhibited in FIGS. 4 and 5 corresponds to the width and orientation of the edge of the contact plug relative the contact finger.

The evidence of corrosion fretting exhibited in FIG. 5 along the contact finger tested in accordance with embodiments presented herein helps verify the success and reliability of such testing by demonstrating the that such test method can create the same corrosion fretting effects as exhibited from use of contact fingers in the field. More particularly, FIG. 4 illustrates a field deployed contact finger exhibiting corrosion fretting whereas FIG. 5 illustrates a lab-generated condition of corrosion fretting pursuant to the test method presented herein. As illustrated in such figures the manner of corrosion fretting generated by the subject test method closely corresponds to the fretting conditions that are being observed in the field.

The testing according to embodiments presented herein provided for the evaluation of several plating methods that exhibited varying degrees of success in addressing the contact condition. Such evaluations have lead to the identification of an improved contact design with improved plating characteristics for optimal performance. More particularly, the optimal contact identified from the test method presented herein reflects improvement over traditional contact designs in several key respects including plating material, plating thickness, plating method, and contact pressure. According to embodiments presented herein, such contact can mitigate the impact of corrosion fretting.

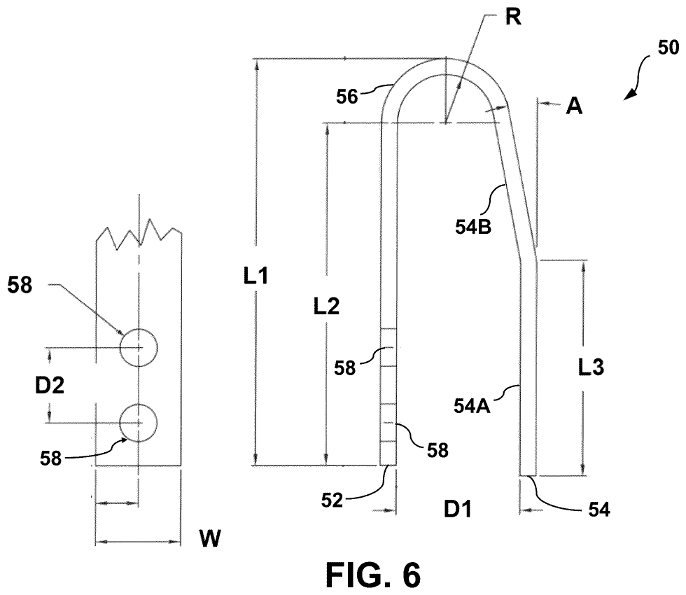

FIG. 6 illustrates a main side elevation view of an exemplary contact finger 50 and corresponding partial rear elevation view of finger 50 according to embodiments presented herein. As shown schematically in FIG. 6, contact finger 50 can have a general U-shaped design with opposing first and second elongated segments 52, 54 joined together by a curved segment 56. Curved Segment 56 can have a radius R on the order of 0.50″ and form a closed end of contact finger 50 opposite an open end at the terminal ends of first and second segments 52, 54. Preferably, the segments 52, 54, 56 of contact finger 50 can have a substantially uniform width W on the order of 1.″ Preferably, contact finger can have a length L1 on the order of 4.5″ to 5.0.″

According to embodiments shown schematically in FIG. 6, first segment 52 can be substantially straight along its length L2 from curved segment 56 to the terminal end of first segment 52 and have openings or holes 58 extending therethrough. First segment 52 can have a length L2 on the order of 3.75″ to 4.25″ and be configured to be fixedly secured to the contact assembly by mechanical fasteners extending through openings 58. Openings 58 in the first segment 52 can be in the order to 0.4 to 0.5″ in diameter and can be spaced apart from one another at a distance D2 on the order of 0.75″ to 1″ on center. The opposing second segment 54 of contact finger 50 can have an bent configuration having a first portion 54A having an outside surface configured to contact a corresponding outside surface of a contact plug. First portion 54A can have a length L2 on the order of 2.25″ to 2.75″. Second segment 54 can bend or slope from portion 54A to a second portion 54B that can join first portion 54A to curved segment 56. The slope or pitch of second portion 54A relative first portion 54B can be at an angle A on the order of between 10 and 12 degrees. The terminal ends of first and second ends 52, 54 can be spaced apart from one another a distance D1 on the order of 0.75″ and 2.25.″ As shown schematically in FIG. 6A, the distance between first and second segments 52, 54 can decrease as the second portion 54B of second segment 54 bends toward the curved segment 56.

The method of testing presented herein for the replication of field conditions for corrosion fretting have brought about advances in the construction and design of contacts over traditional contact designs in several key respects including plating material, plating thickness, methods of plating, and the application of contact pressure. Testing of contacts embodying such advancements have been shown to mitigate the impacts of corrosion fretting. More particularly, embodiments presented herein can provide a contact having a new and improved composition of plating materials over plating used with conventional contact fingers which are typically comprised of a silver base plate with an additional layer of tin on top of the copper contact finger. Such plating is generally utilized along the entire contact finger in a conventional contact design. By contrast, the improved plating composition of a contact according to embodiments presented herein can differ from conventional plating compositions by featuring a layer of silver on top of the copper contact finger along the contact area location and a layer of tin on the copper finger at the location where the finger bolts to the aluminum contact assembly. Such modification over traditional contact plating avoids the utilization of tin from the moving contact area which can produce non-conductive oxides that can lead to corrosion fretting.

Embodiments presented herein can further provide a new approach with respect to the thickness of the plating material and the method of finish. More particularly, the plating of conventional contacts typically exhibit a layer of matte silver having a thickness on the order of 0.0005″ with a layer of tin having a thickness on the order of 0.0005″ over the top of the matte silver. By contrast, embodiments presented herein can comprise modified composition whereby the layer of silver at the contact area location can have a semi-bright finish and a thickness on the order of 0.0008.″ Such composition can comprise a sixty percent (60%) increase in the thickness of the silver over conventional contact platings. Moreover, the change to a semi-bright method of finish can increase the hardness of the plating. Such differences, can make the surface of the contact according to embodiments presented herein more resistant to mechanical wear of corrosion fretting.

Switch contacts according to embodiments presented herein can also differ from conventional contact designs by incorporating features that can increase the contact pressure on the order of thirty percent (30%). More particularly, according to embodiments presented herein, the contact pressure can be increased the incorporating a larger gauge biasing member or spring behind the contact finger to exert increased pressure against the surface of the contact plug. Such increased pressure can increase the resistance of movement between the outside surface of the contact finger and corresponding outside surface of the plug. Such increase in contact pressure can lower the amplitude of micro-movements between the finger and the contact plug which can lead to corrosion fretting.

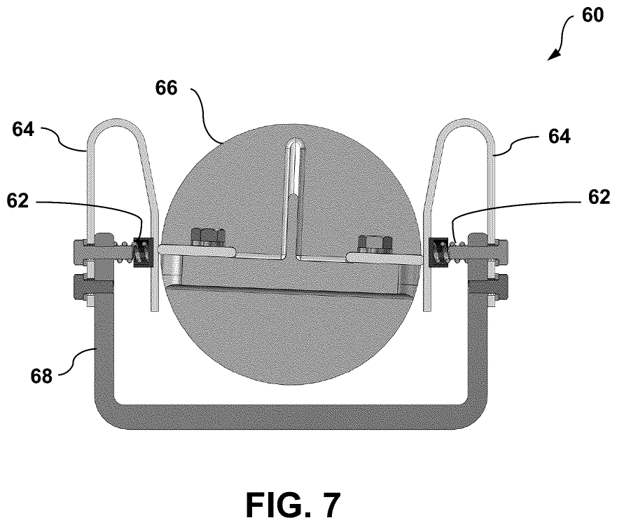

FIG. 7 is a cross-section view illustrating an exemplary contact assembly 60 according to embodiments presented herein. As shown schematically in FIG. 7, the contact assembly 60 can comprise a contact body 68, a contact plug 66 having opposing side edges, a plurality of contacts 64 on each side of the contact plug 66 and a plurality of a biasing members 62 associated with each of the contacts 64. According to embodiments shown in FIG. 7, the contact body can comprise a c-shaped frame member having a central channel between opposing parallel first and second flanges extending from opposing sides of the channel. The plurality of contacts can be as described previously herein and comprise U-shaped copper band comprising a first and second segments having first terminal ends and opposing ends joined together by a curved segment. The first segment of the contact can be substantially straight along its length and the second segment can have a bend along its length between a first portion and a second portion. The first portion of the second member can be substantially parallel to first member and the second portion of the second member can angle toward the first member as it extends from the first segment to the curved segment. The first portion of the second segment of the copper body can be covered by a silver plating along at least a portion thereof and the first segment of copper body can be covered by a plating of tin along at least a portion thereof.

As shown schematically in FIG. 7, contacts 64 can be fixedly secured to the first and second flanges of the contact body 68 and be positioned on each side of the contact plug 66. Each contact can be associated with a biasing member 62 such as a spring can be located behind the segment of the contact finger 64 that is in contact with the contact plug 66. Each biasing member 62 can extend between the inside surface of the flange and the inside surface of its associated contact 64 in the space therebetween and can provide a force to influence the second segment of the contact 64 toward the adjacent outer edge of the contact plug 66 such that the outer surface of the second segment of the contact 64 is engaged against the adjacent edge of the contact plug 66. According to embodiments presented herein, the spring or biasing member 62 can increase the contact pressure at the location of contact between the outer surface of the bent segment of contact finger 62 and the outer edge of the contact plug 66. Such spring can be an A-23362-type spring having a spring rate on the order of 721 #/in. Accordingly, the springs can be compressed in the space between the flange of the contact body 68 and the adjacent inside surface of the associated contact 64. The springs 62 can gave an equilibrium position that forces the spring to expand inward toward an adjacent outer edge of the contact plug. According to the test method specified herein, such spring was identified as being an improvement over springs utilized by conventional contacts such as A-10091-type springs to impede movement between the outside surface of the contact finger and corresponding outside surface of the plug.

Incorporation of the combined design elements presented herein, namely a new a different the plating composition, plating thickness and method of finish, together with an increase in contact pressure has demonstrated in laboratory testing a net performance improvement of 3,300% in preventing the induction of corrosion fretting on the contact fingers. Such results validate the utility of the test method and novel switch contact design presented herein and reflect the establishment of a material improvement and inventive step over conventional switch designs and test methods.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be add to, or removed from the described embodiments.

What is claimed is:

1. A method of testing contacts of a high voltage switch to replicate corrosion fretting exhibited by switches used with renewable energy generators, the method comprising:
constructing a test assembly comprising a vertical break test switch having a plurality of contacts, the test switch connected to a high current, low voltage continuous current test loop;
attaching a plurality of thermocouples along multiple locations on the test switch, plurality of contacts and test assembly;
mounting a vibratory motor to the test assembly;
overloading the plurality of contacts by applying current to the test assembly in an amount more than two times a designated current density for said plurality of contacts;
allowing the plurality of contacts to reach a thermal equilibrium and activating the vibratory motor, and
operating the switch until the plurality of contacts achieve a temperature increase higher than an ambient temperature for the plurality of contacts.

2. The method of claim 1 wherein the plurality of contacts comprises two contacts, each of the two contacts having an outer surface engaged against an outer edge of a contact plug.

3. The method of claim 2 wherein the corrosion fretting is exhibited along the outside surface of the contacts, the corrosion fretting being presented as a linear path of wear extending horizontally across the outside surface of the contacts.

4. The method of claim 1 wherein the vertical break test switch is a 34 kV, 4000 A switch.

5. The method of claim 1 wherein the current applied to the test assembly to overload the plurality of contracts is 2000 amps.

6. The method of claim 1 wherein the plurality of contacts are overloaded by the application of current in an amount of at least two and a half times the designated current density for said plurality of contacts.

7. The method of claim 1 wherein the plurality of contacts are unlubricated.

8. The method of claim 1 further comprising operating the vibratory motor at 2400 revolutions per minute and producing a movement amplitude on an order of 0.0005 inches.

9. The method of claim 1 wherein the switch is operated until the plurality of contacts achieve a temperature increase of at least ten percent higher than the ambient temperature for the plurality of contacts.

10. A contact for a high voltage switch comprising:
a copper body comprising a U-shaped band comprising a first and second segments having first terminal ends and opposing ends joined together by a curved segment, the first segment being substantially straight along its length, the second segment having a bend along its length between a first portion and a second portion, the first portion of the second member being substantially parallel to first member and the second portion of the second member angling toward the first member as it extends from the first segment to the curved segment;
wherein the first portion of the second segment of copper body is covered by a silver plating along at least a portion thereof, and the first segment of copper body is covered by a plating of tin along at least a portion thereof.

11. The contact of claim 10 wherein the silver plating covers a contact surface for engaging against a side of a contact plug.

12. The contact of claim 10 wherein the silver plating has a semi-bright finish and a thickness on the order of between 0.0005 and 0.0012 inches.

13. The contact of claim 10 wherein the first segment has at least one opening therethrough for fixedly securing the contact to a contact assembly.

14. The contact of claim 12 wherein the silver plating has a thickness on the order of 0.0008 inches.

15. The contact of claim 14 wherein the plating of tin is provided in a location of the at least one opening.

16. A contact assembly for a high voltage switch comprising:
a contact body comprising a c-shaped member having a central channel between opposing parallel first and second flanges extending from opposing sides of the channel;
a plurality of contacts, each contact a comprising U-shaped copper band comprising a first and second segments having first terminal ends and opposing ends joined together by a curved segment, the first segment being substantially straight along its length, the second segment having a bend along its length between a first portion and a second portion, the first portion of the second member being substantially parallel to first member and the second portion of the second member angling toward the first member as it extends from the first segment to the curved segment, wherein the first portion of the second segment of the copper body is covered by a silver plating along at least a portion thereof, and the first segment of copper body is covered by a plating of tin along at least a portion thereof,
the plurality of contacts comprising a first contact secured to the first flange of the contact body and a second contact fixedly secured to the second flange of the contact body, the first contact being secured such that at least a portion of the second segment of the first contact extends into the channel of the contact body and is adjacent to an interior surface of the first flange with a space therebetween, the second contact being secured such that at least a portion of the second segment of the second contact extends into the channel of the contact body and is adjacent to an interior surface of the second flange with a space therebetween;
a contact plug within the channel of the contact body, the contact plug having first and second outer edges;
a plurality of biasing members comprising a first biasing member secured to the first flange of the contact body and a second biasing member secured to the second flange of the biasing member,
wherein, the first biasing member extends between the inside surface of the first flange and the inside surface of the first contact in the space therebetween, the first biasing member providing a force to influence the second segment of the first contact toward the first outer edge of the contact plug such that the outer surface of the second segment of the first contact is engaged against the first outer surface of the contact plug,
wherein, the second biasing member extends between the inside surface of the second flange and the inside surface of the second contact in the space therebetween, the second biasing member providing a force to influence the second segment of the second contact toward the second outer edge of the contact plug such that the outer surface of the second segment of the second contact is engaged against the second outer surface of the contact plug.

17. The contact assembly of claim 16 wherein the plurality of biasing members are springs are compressed in a respective space between one of the first and second flanges of the contact body and the inside surface of the second segment of a respective one of the first and second contacts, the springs having an equilibrium position that forces the springs inward toward a respective one of the first and second outer edge of the contact plug.

18. The contact assembly of claim 17 wherein the springs are an A-23362-type spring having a spring rate on the order of 721 #/in.

19. The contact assembly of claim 16 wherein the silver plating along the Copper body of the plurality of contacts covers a contact surface between a respective one of the plurality of contacts and a respective one of the first and second outer edge of the contact plug.

20. The contact of claim 16 wherein the silver plating has a semi-bright finish and a thickness on the order of between 0.0005 and 0.0012 inches.

21. The contact of claim 16 wherein the first segment of each of the plurality of contacts has at least one opening therethrough for fixedly securing the contact to the contact body.

22. The contact of claim 20 wherein the silver plating has a thickness on the order of 0.0008 inches.

23. The contact of claim 16 wherein the plating of tin is provided in a location of the at least one opening.
